(19) United States
(12) Patent Application Publication
(10) Pub. No.: US 2024/0000217 A1
(43) Pub. Date: Jan. 4, 2024

(54) METHOD FOR POSITIONING HAIRLINE CONTOURS WITH DIFFERENT HEAD CIRCUMFERENCE SIZES, HEAD MODEL AND WIG

(71) Applicants: Zhuyong YUAN, Qingdao (CN); Haolin YUAN, Qingdao (CN)

(72) Inventors: Zhuyong YUAN, Qingdao (CN); Haolin YUAN, Qingdao (CN)

(21) Appl. No.: 18/337,463

(22) Filed: Jun. 20, 2023

(30) Foreign Application Priority Data
Jun. 30, 2022 (CN) 202210763539.7

(51) Int. Cl. A45D 44/00; A41G 3/00

(52) U.S. Cl. CPC A45D 44/005; A41G 3/00

(57) ABSTRACT

A method for positioning hairline contours with different head circumference sizes includes: determining a trichion, where the trichion is located at a center of a top of a forehead; determining a center point of a head, where the center point of the head is located on a surface of a skull top; determining a skull top U-shaped line based on the trichion and the center point of the head; determining frontal horn points based on the skull top U-shaped line and temporal bone lines of the head; determining front side points; determining sidebums points; determining ear points; determining neck side points; determining a skull base line; connecting, based on a trend of facial muscles, the trichion, the frontal horn points, the front side points, the sidebums points, the ear points, the neck side points and the skull base line in a smooth transition manner in, to obtain a hairline contour.

### CROSS-REFERENCE TO RELATED APPLICATIONS

This application claims priority to Chinese Patent Application No. 202210763539.7 with a filing date of Jun. 30, 2022. The content of the aforementioned application, including any intervening amendments thereto, is incorporated herein by reference.

### FIELD

The present application relates to the technical field of human head model teaching aids, and in particular to a method for positioning hairline contours with different head circumference sizes, a head model and a wig.

### BACKGROUND

In wig design, wig shaping and hairdressing teaching, a head model on which a hairline and head division of a human head can be marked is required. In order to prepare the model, a method that can determine corresponding hairline contours under different head circumference sizes is required. By using this method, positions of different points on the hairline and head dividing lines can be determined, thereby drawing the hairline contour.

However, it is difficult to find a simple and feasible method in the conventional technology to determine the hairline contours under different head circumference sizes, resulting in most of the head models being a standard model and not fitting with the heads of real people with differences. The experience of hair cutting and wig making learned through the standard model is difficult to fit with the real people in the practical operation process, leading to a deviation between the theory in the learning process and the operation technology in the practical process.

Therefore, it is required to provide a new technical solution to solve the problems existing in the conventional technology.

### SUMMARY

A method for positioning hairline contours with different head circumference sizes, a head model and a wig are provided according to the present application, so as to solve the problem that it is difficult to determine the hairline contours with different head circumference sizes in the conventional technology.

In order to realize the above object, the following technical solutions are provided according to the present application.

In an aspect, a method for positioning hairline contours with different head circumference sizes is provided according to the present application, which includes the following steps:

S1: determining a trichion, where the trichion is located at a center of a top of a forehead;

S2: determining a center point of a head, where the center point of the head is located on a surface of a skull top and is a center point of a total head length, and the total head length is a connecting line between a highest point on a forehead surface and a highest point on a back surface of the head;

S3: determining a skull top U-shaped line based on the trichion and the center point of the head;

S4: determining frontal horn points based on the skull top U-shaped line and temporal bone lines of the head;

S5: determining front side points;

S6: determining sidebums points;

S7: determining ear points;

S8: determining neck side points;

S9: determining a skull base line; and

S10: connecting, based on a trend of facial muscles, the trichion, the frontal horn points, the front side points, the sidebums points, the ear points, the neck side points and the skull base line in a smooth transition manner in a listed sequence, to obtain a hairline contour.

Based on the above technical solution, further, a vertical distance from the trichion in step S1 to the skull top is equal to a difference between a total head height and a face length, the total head height is a vertical distance from the skull top to a mandible bottom, and the face length is a vertical distance from the mandible bottom to the trichion.

Further, in step S3, the determining a skull top U-shaped line includes the following steps:

S31: determining a centerline of a skull, where the centerline of the skull passes through the trichion and the center point of the total head length in a listed sequence, and the centerline of the skull divides the skull into a left half and a right half;

S32: rotating the centerline of the skull by 45 degrees to a left side and a right side to obtain a left auxiliary line and a right auxiliary line, where a rotation center is the center point of the head; rotating the centerline of the skull by 90 degrees to obtain a head width auxiliary line perpendicular to the centerline of the skull, where the rotation center is the center point of the head, and the head width auxiliary line divides the skull into a front half and a rear half; and

S33: determining, on a surface of the skull, positioning points located at the centerline of the skull, the left auxiliary line, the right auxiliary line and the head width auxiliary line based on the vertical distance from the trichion to the skull top, where a vertical height from each of the positioning points to the skull top is the same as the vertical height from the trichion to the skull top; and connecting the positioning points sequentially to obtain the skull top U-shaped line.

The centerline of the skull and the skull top U-shaped line intersect at two intersections, one of the intersections is the trichion, another of the intersections is a golden section point, where the golden section point is a point at which the surface of the skull intersects with a bisector of an included angle, formed by a horizontal straight line passing through a highest point on the skull top and a vertical straight line passing through the highest point on the back surface of the head.

Further, the determining frontal horn points based on the skull top U-shaped line and temporal bone lines of the head in step S4 includes:

each of a left side and a right side of the forehead of a face is provided with a frontal horn point, and the two frontal horn points are intersections between temporal bone lines on two sides and the skull top U-shaped line, respectively.

Furthermore, the two frontal horn points are referred to as a left frontal horn point and a right frontal horn point, where the left frontal horn point is an intersection between the left auxiliary line and a portion, close to the forehead, of the skull top U-shaped line; and the right frontal horn point is an intersection between the right auxiliary line and the portion, close to the forehead, of the skull top U-shaped line.

Further, the determining front side points in step S5 includes:

each of a left side and a right side of a face is provided with a front side point, where the front side points are located on two sides of the forehead and located at intersections between the temporal bone lines and a skull line, respectively;

the front side points include a first front side point and a second front side point;

the first front side point is located above the second front side point, and the first front side point is closer to the forehead surface than the second front side point;

the first front side point is an intersection between the left auxiliary line and a left temporal bone line, or, the first front side point is an intersection between the right auxiliary line and a right temporal bone line;

a connecting line between the first front side point and the second front side point on a same side is parallel to a straight line at an angle of 45 degrees obliquely downward from an upper edge of an orbit, and intersects with an extended straight line of a brow bone; and

the second front side point is an intersection between the straight line at the angle of 45 degrees obliquely downward from the upper edge of the orbit and the extended straight line of the brow bone.

Further, the determining sidebums points in step S6 includes:

each of the left side and the right side of the face is provided with a sidebums point, where each of the sidebums points is an intersection between an end of a facial zygomatic bone and an auricular bone;

the front side points, the sidebums points and the ear points are connected to form a sidebums hairline contour, where the sidebums hairline contour includes a first-section sidebums hairline contour and a second-section sidebums hairline contour;

the first-section sidebums hairline contour is formed by the second front side point intersecting vertically downward with a side zygomatic bone; and

the second-section sidebums hairline contour is formed by extending each of the ear points obliquely downward along a corresponding ear to intersect with the end of the side zygomatic bone, and the first-section sidebums hairline contour and the second-section sidebums hairline contour intersect at the sidebums point.

Further, the determining ear points in step S7 includes:

ears are formed on a left side and a right side of the skull, and the ear points are located above the ears; where each of the ear points is an intersection between the head width auxiliary line and a skull line above a corresponding ear, and a connecting line between the ear point and the sidebums point follows a trend of the skull line.

Further, the determining neck side points in step S8 includes:

the neck side points are located at a back of the head and opposite to a face, a left side and a right side of the back of the head are symmetrically provided with the neck side points, which are referred to as a left neck side point and a right neck side point;

the left neck side point is an intersection between a line, which extends downward along the surface of the skull from a starting point, and an extension line of a connecting line between a nasal floor and an ear floor on the surface of the skull, where the starting point is an intersection between an end, close to the back of the head, of the right auxiliary line and the skull top U-shaped line;

the right neck side point is an intersection between a line, which extends downward along the surface of the skull from a starting point, and an extension line of a connecting line between the nasal floor and an ear floor on the surface of the skull, where the starting point is an intersection between an end, close to the back of the head, of the left auxiliary line and the skull top U-shaped line;

where the line that extends downward along the surface of the skull from the starting point, which is the intersection between the end, close to the back of the head, of the right auxiliary line and the skull top U-shaped line, is referred to as a left corner line, and the line that extends downward along the surface of the skull from the starting point, which is the intersection between the end, close to the back of the head, of the left auxiliary line and the skull top U-shaped line, is referred to as a right corner line;

a connecting line between the ear point and the left neck side point or a connecting line between the ear point and the right neck side point is referred to as an auricular line, and the auricular line is a curve that extends and transits forward along the skull line at a back of the ear.

Further, the determining a skull base line in step S9 includes:

the skull base line is located at the back of the head and below the left neck side point and the right neck side point, where the skull base line is an extension line of a connecting line between two ends of corners of a mouth along the surface of the skull, the skull base line forms a dividing line between the head and a neck, the left neck side point and the right neck side point each is connected with the skull base line through a transition line, and the transition lines are smooth curves.

In another aspect, a head model is provided according to the present application, a hairline contour is drawn on the head model, and the hairline contour is drawn by using the method for positioning hairline contours with different head circumference sizes. The hairline contour on the head model is divided into a top horseshoe region, a posterior brain region, a left brain region and a right brain region; where the top horseshoe region is surrounded by the skull top U-shaped line at the skull top of the head model;

the posterior brain region is surrounded by the left corner line, the right corner line, the skull top U-shaped line and the skull base line;

the left brain region is surrounded by the left corner line, the skull top U-shaped line and a left part of the hairline contour; and

the right brain region is surrounded by the right corner line, the skull top U-shaped line and a right part of the hairline contour.

Further, the trichion and the golden section point are indicated on the centerline of the skull of the head model.

In yet another aspect, a wig is provided according to the present application, which includes a net base. A contour of the net base is adapted to a hairline contour of a human head; and the contour of the net base is drawn by using the method for positioning hairline contours with different head circumference sizes.

Compared with the conventional technology, the present application has the following beneficial effects.

The method for positioning hairline contours with different head circumference sizes according to the present application can be used to determine and calculate the positioning of points and the division of the contour lines on the hairline contours of the human heads under different head circumference sizes. A head model on which the hairline and the division of the human head can be marked is provided for wig design, wig shaping, and hairdressing teaching. In wig production, the hairline contours with different head circumferences sizes can be determined by using the method for positioning hairline contours with different head circumference sizes, and the auxiliary lines for the design of the net base of the wig can be obtained, which is convenient for designers to find out angles of dividing lines at the back of the net cap, and make a wig that is more suitable for the human head. With the method for positioning hairline contours with different head circumference sizes according to the present application, a theoretical basis is provided for a method for drawing the hairline contours under different head circumference sizes, which facilitates the relevant operators to deepen their perception of the hairline contours, thereby improving a matching degree of technology applied in the practical operation process.

### BRIEF DESCRIPTION OF THE DRAWINGS

In order to more clearly illustrate technical solutions in embodiments of the present application, the drawings used in the description of the embodiments are briefly described hereinafter. Apparently, the drawings described below illustrate only some embodiments of the present application. Other drawings may be obtained by those skilled in the art based on the drawings without any creative efforts. It should be understood that the specific shapes and structures shown in the drawings should not be generally considered as limiting conditions for realizing the present application. For example, based on the technical concepts and exemplary drawings disclosed in the present application, those skilled in the art are capable of easily making routine adjustments or further optimization on the addition/subtraction/attribution division, specific shape, positional relationship, connection method, size proportion relationship, of some units (components).

FIG. 1 is a model diagram showing a distribution trend of muscle tissue of a human head viewed from a side perspective;

FIG. 2 is a model diagram showing the distribution trend of the muscle tissue of the human head viewed from a front perspective;

FIG. 3 is a schematic diagram for describing a principle of a method for positioning hairline contours with different head circumference sizes according to the present application by using a human head model in an embodiment;

FIG. 4 is a schematic diagram of a plane structure of the human head model shown in FIG. 3 viewed from a top perspective, which mainly describes the principle of the method for positioning hairline contours with different head circumference sizes according to the present application in conjunction with FIG. 3;

FIG. 5 is a schematic diagram of the planar structure of the human head model shown viewed from the top perspective according to an embodiment of the present application, which mainly shows a skull top U-shaped line on the head model;

FIG. 6 is a schematic diagram of the planar structure of the human head model shown viewed from a rear perspective according to an embodiment of the present application, which mainly describes the principle of the method for positioning hairline contours with different head circumference sizes according to the present application in conjunction with FIG. 3;

FIG. 7 is a schematic perspective structural view of the human head model according to an embodiment of the present application, which mainly shows that the hairline contour is drawn on the human head model and the head model is accurately divided by using the method for positioning hairline contours with different head circumference sizes according to the present application.

Reference numerals in the drawings are listed as follows:

| | |
|---|---|
| 1, trichion; | 2, left frontal horn point; |
| 21, right frontal horn point; | 3, first front side point; |
| 4, second front side point; | 5, sidebums point; |
| 6, ear point; | 7, neck side point; |
| 8, golden section point; | 9, center point of head; |
| A, skull top U-shaped line; | B, head width auxiliary line; |
| C, centerline of skull; | D, right auxiliary line; |
| E, left auxiliary line; | F, left corner line; |
| G, right corner line; | H, skull base line. |

### DETAILED DESCRIPTION OF THE EMBODIMENTS

The present application is further described in detail through specific embodiments in conjunction with the accompanying drawings.

In the description of the present application, the word “multiple” indicates two or more, unless otherwise specified. The terms “first”, “second”, “third” and the like in the present application are intended to distinguish the objects referred to and have no particular meaning in terms of technical connotation (for example, they should not be understood as an emphasis on importance, order, or the like). The expressions such as “including”, “containing” and “having” imply “not limited to” (units, parts, materials, steps, or the like.).

The terms such as “upper”, “lower”, “left”, “right”, “middle” and the like in the present application are generally for the convenience of intuitive understanding with reference to the accompanying drawings, and are not absolute limitations on positional relationships of actual products. Without departing from the technical concept disclosed in the present application, changes in relative positional relations should be considered to be within the scope of the description in the present application.

### First Embodiment

In wig design, a cap base of a wig may be made by using a machine-made cap base or a hand-crocheted cap base. In the process of making the cap base, a head model marked with sizes and head division is required.

Hairline contours and head division of head models with different sizes can be positioned and drawn by using a method for positioning hairline contours with different head circumference sizes according to the present application, so as to obtain differentiated head models. Differentiated wigs can be correspondingly made through the differentiated head models.

The head model is an auxiliary model corresponding to the human head. In order to describe the structure of the head model and the method for positioning hairline contour according to the present application, the structure of the human head is briefly introduced below.

The human head has a boundary. In anatomy, the head is divided into a skull at a posterior upper portion and a face at an anterior lower portion. There is a dividing line between the skull and the face, which is formed by connecting an upper orbital margin, an upper zygomatic arch margin, an upper external auditory meatus margin, and a mastoid process in a listed sequence. In order to facilitate understanding, in popular terms, the upper orbital margin is an upper edge of an orbit, and is a position where an eyebrow is attached. The zygomatic arch (that is, the temporal process of the zygomatic bone and the zygomatic process of the temporal bone) is a bone that extends from a zygomatic bone toward an ear. The upper external auditory meatus margin is substantially close to an external auditory meatus. The mastoid process is a protrusion behind an earlobe.

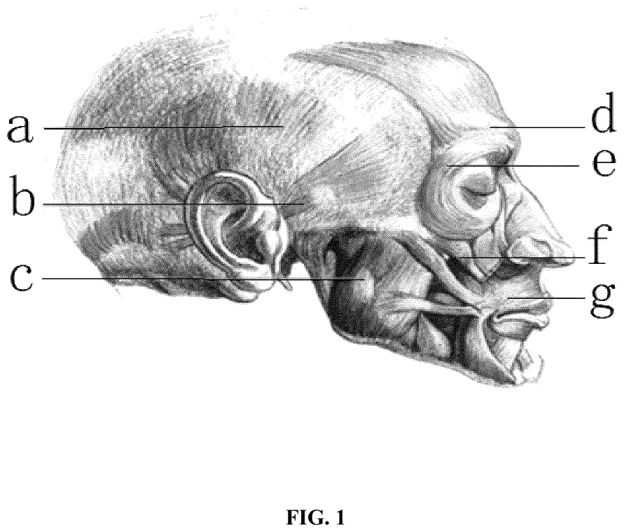

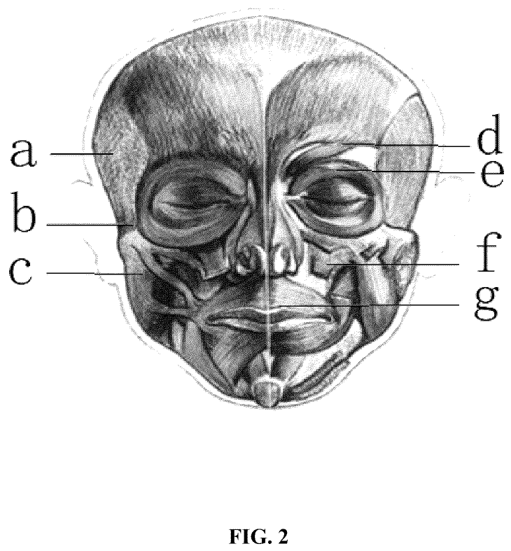

After data query, it is found that most of human heads in European and American countries are flat, with a maximum length-width ratio of the head of 1.18. The distribution of hairline is generally formed by gradual degradation along the distribution of bones and muscle soft tissues of the head, and structural diagrams of the bones and muscle tissues of the head may be referred to FIG. 1 and FIG. 2. FIG. 1 shows a distribution trend of muscle tissue of a human head viewed from a side perspective, and FIG. 2 shows a distribution trend of the muscle tissue of the human head viewed from a front perspective. In the drawings, a, represents temporalis; b represents zygomaticus; c represents masseter; d represents corrugator; e represents orbicularis oculi; f represents buccinator; and g represents orbicularis oris. It can be clearly seen from FIG. 1 and FIG. 2 that the distribution trend of the hairline of the human head is substantially the same as the distribution trend of the muscle tissue, and each of points on the hairline is closely related to the structure of facial features and the structure of a skull.

Based on the bone structure and the distribution of muscle tissue of the human head, and the proportion of the human face, in combination with the average measurement data of the human heads at home and abroad and the distribution law of the hairline of the human head, the law and calculation method of the relative relationship between the distribution of the hairline of the human head and the positions and sizes of facial features of the human head are obtained through surveying and mapping an actual model, and the method is specifically as follows:

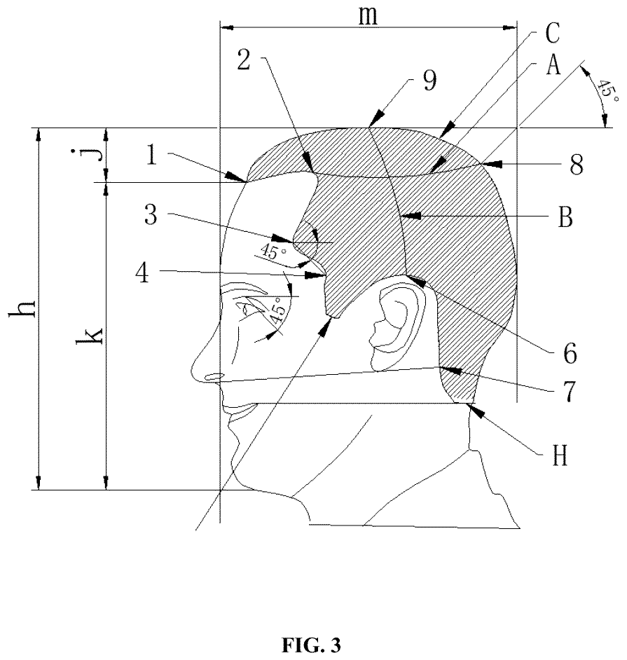

Referring to FIG. 3, the hairline of the human head is formed by connecting a trichion 1 (that is, a vertex of a forehead hairline), frontal horn points, front side points, sidebums points 5, ear points 6, and neck side points 7 in a listed sequence.

A standard face conforms to the division of the face being equally divided into three parts in a length direction and five parts in a width direction, that is, a face length (from the trichion 1 to the mandible) is equally divided into three parts, a head width is equal to a width of five eyes, and the equally division of the three parts of the face is implemented as that: a first part is from the trichion 1 to a brow bone; a second part is from the brow bone to a nasal floor; a third part is from the nasal floor to a mandible bottom, and the three parts have the same size. The hairline included in the face mainly includes the following positioning points: the trichion 1, the frontal horn points on two sides, the front side points on two sides and the sidebums points 5. The method for determining the above points are detailed as follows.

1. The trichion 1 is located on a centerline of a face and located at a center of a top of a forehead, and is a highest point on the face. Referring to FIG. 3, a total head height (that is, a vertical distance from a skull top to a mandible bottom) is represented as h, a face length (that is, a vertical distance from the mandible bottom to a vertex of the forehead hairline) is represented as k, a hairline height (that is, a vertical distance from the trichion 1 to the skull top) is represented as j, then the hairline height j=h-k.

A size from the trichion 1 of the facial hairline to the mandible (that is, the face length k) is substantially equal to a front-back length of the head (that is, a vertical distance from a highest point on a forehead surface to a highest point on a back surface of the head, or a total head length m). Therefore, the position of the trichion 1 under different head circumferences can be obtained under the condition that the total head length and the total head height are known.

2. A center point 9 of the head is a center point of the total head length m.

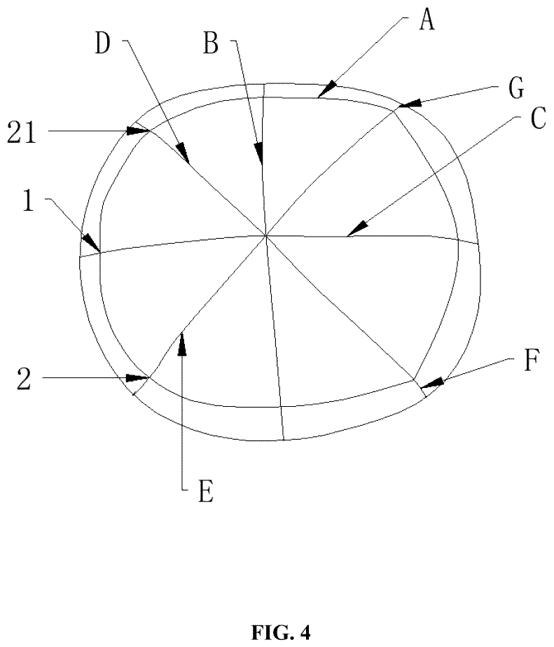

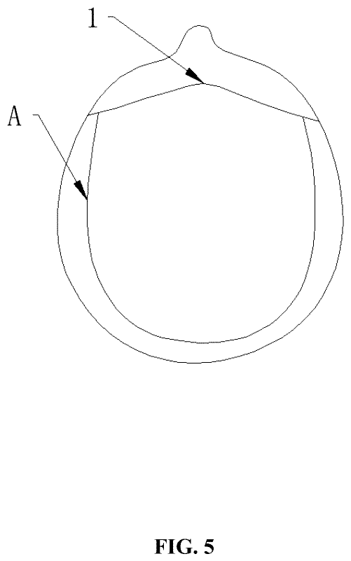

3. A method for positioning the contour of a skull top U-shaped line A, on which a golden section point 8 of the head (which may be referred to as hair-whirlpool) is distributed, is described as follows, as shown in FIG. 3, FIG. 4 and FIG. 5:

(1) determining a centerline C of a skull, where the centerline C of the skull passes through the trichion 1 and the center point of the total head length in a listed sequence, and the centerline C of the skull divides the skull into a left half and a right half;

(2) rotating the centerline C of the skull by 45 degrees to a left side and a right side to obtain a left auxiliary line E and a right auxiliary line D, where a rotation center is the center point of the total head length; rotating the centerline C of the skull by 90 degrees to obtain a head width auxiliary line B perpendicular to the centerline C of the skull, where the rotation center is the center point of the total head length, and the head width auxiliary line B divides the skull into a front half and a rear half; and

(3) determining positioning points located at the centerline C of the skull, the left auxiliary line E, the right auxiliary line D and the head width auxiliary line B based on the vertical distance from the trichion 1 to the skull top, where a vertical height from each of the positioning points to the skull top is the same as the vertical height from the trichion 1 to the skull top; and connecting the positioning points sequentially to obtain the skull top U-shaped line A.

Referring to FIG. 4, the centerline C of the skull and the skull top U-shaped line A intersect at two intersections, one of the intersections is the trichion 1, and another of the intersections is a golden section point 8. The golden section point 8 is a point at which the surface of the skull intersects with a bisector of an included angle, formed by a horizontal straight line passing through a highest point on the skull top and a vertical straight line passing through the highest point on the back surface of the head.

4. The frontal horn points are determined by the following manner: referring to FIG. 3, each of a left side and a right side of the forehead of the face is provided with a frontal horn point, and the two frontal horn points are intersections between the temporal bone lines on two sides and the skull top U-shaped line A, respectively; a left frontal horn point 2 is located at an intersection between the left auxiliary line E and a portion, close to the forehead, of the skull top U-shaped line A; and a right frontal horn point 21 is located at an intersection between the right auxiliary line D and the portion, close to the forehead, of the skull top U-shaped line A.

5. The front side points are determined by the following manner: referring to FIG. 3, each of a left side and a right side of the face is provided with a front side point, the front side points are located on two sides of the forehead and located at intersections between the temporal bone lines and a skull line, respectively. The front side points include a first front side point 3 and a second front side point 4. The first front side point is 3 located above the second front side point 4, and the first front side point 3 is closer to the top of the forehead than the second front side point 4. The front side point of a left face is described as an example, referring to FIG. 3, the first front side point 3 on the left face is an intersection between the left auxiliary line D and the temporal bone line. A connecting line between the first front side point 3 and the second front side point 4 is parallel to a straight line at an angle of 45 degrees obliquely downward from an upper edge of an orbit, and intersects with an extended straight line of a brow bone. The second front side point 4 is an intersection between the straight line at the angle of 45 degrees obliquely downward from the upper edge of the orbit and the extended straight line of the brow bone.

6. The sidebums points 5 are determined by the following manner: referring to FIG. 3, each of the left side and the right side of the face is provided with a sidebums point 5, and each of the sidebums points 5 is an intersection between an end of a facial zygomatic bone and an auricular bone. The sidebums hairline contour includes a first-section sidebums hairline contour and a second-section sidebums hairline contour: the first-section sidebums hairline contour is formed by the second front side point 4 intersecting vertically downward with a side zygomatic bone; the second-section sidebums hairline contour is formed by extending each of the ear points 6 obliquely downward along a corresponding ear to intersect with the end of the side zygomatic bone, and the first-section sidebums hairline contour and the second-section sidebums hairline contour intersect at the sidebums point 5.

7. The ear points 6 are determined by the following manner: referring to FIG. 3, ears are formed on a left side and a right side of the skull, and the ear points 6 are located above the ears. Each of the ear points 6 is an intersection between the head width auxiliary line and a skull line above a corresponding ear, and a connecting line between the ear point 6 and the sidebums point 5 follows a trend of the skull line.

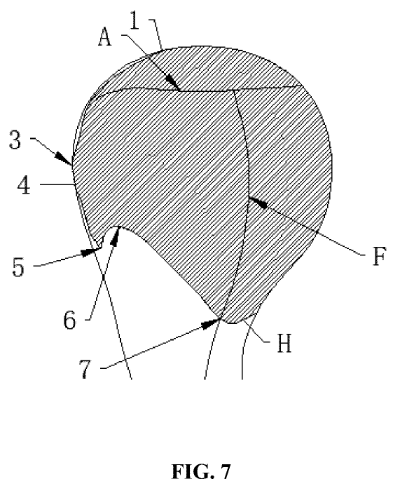

8. The neck side points 7 are determined by the following manner: referring to FIG. 3 and FIG. 7, the neck side points 7 are located at the back of the head and opposite to the face. A left side and a right side of the back of the head are symmetrically provided with the neck side points 7, which are referred to as a left neck side point 7 and a right neck side point 7. The left neck side point 7 is an intersection between a line, which extends downward along the surface of the skull from a starting point, and an extension line of a connecting line between a nasal floor and an ear floor on the surface of the skull, where the starting point is an intersection between an end, close to the back of the head, of the right auxiliary line D and the skull top U-shaped line A. Similarly, the right neck side point 7 is an intersection between a line, which extends downward along the surface of the skull from a starting point, and an extension line of a connecting line between the nasal floor and an ear floor on the surface of the skull, where the starting point is an intersection between an end, close to the back of the head, of the left auxiliary line E and the skull top U-shaped line A.

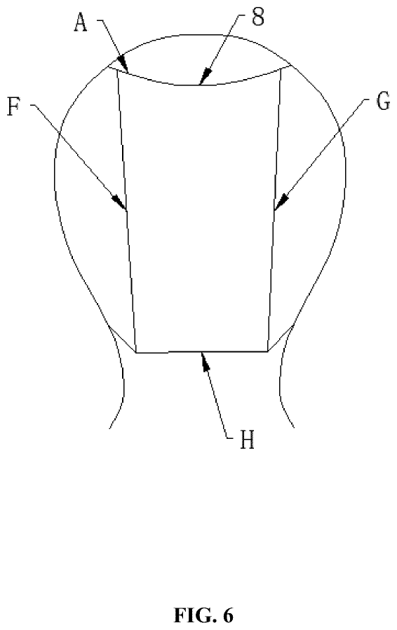

Referring to FIG. 4, FIG. 6 and FIG. 7, the line that extends downward along the surface of the skull from the starting point, which is the intersection between the end, close to the back of the head, of the right auxiliary line D and the skull top U-shaped line A, is referred to as a left corner line F, and the line that extends downward along the surface of the skull from the starting point, which is the intersection between the end, close to the back of the head, of the left auxiliary line E and the skull top U-shaped line A is referred to as a right corner line G.

Referring to FIG. 3 and FIG. 7, a connecting line between the ear point 6 and the left neck side point 7 or a connecting line between the ear point 6 and the right neck side point 7 is referred to as an auricular line, and the auricular line is a curve that extends and transits forward along the skull line at a back of the ear.

9. A skull base line H is determined by the following manner: referring to FIG. 3 and FIG. 7, the skull base line H is used to connect the left neck side point 7 to the right neck side point 7. The skull base line H is located below the left neck side point 7 and the right neck side point 7, the skull base line H is an extension line of a connecting line between two ends of corners of a mouth along the surface of the skull, the skull base line H is located at the back of the head, the skull base line H forms a dividing line between the head and the neck, and the left neck side point 7 and the right neck side point 7 each is connected with the skull base line H through a transition line.

After the trichion 1, the frontal horn points, the front side points, the sideburns points 5, the ear points 6, the neck side points 7 and the skull base line H are determined by using the above method, the hairline contour can be obtained by connecting all the points in a smooth transition manner in a listed sequence based on a trend of facial muscles.

After the hairline contour is obtained, the head can be accurately divided, as shown in FIG. 6 to FIG. 7, the skull top U-shaped line U divides the skull top into a top horseshoe region. A posterior brain region is surrounded by a left corner line F, a right corner line G, the skull top U-shaped line A and the skull base line H, a left brain region is surrounded by the left corner line F, the skull top U-shaped line A and the hairline contour on the left side, and a right brain region is surrounded by the right corner line G, the skull top U-shaped line A and the hairline contour on the right side.

In wig design, the skull top U-shaped line A, the posterior brain region, the right brain region, and the left brain region are commonly used. The centerline C of the skull, and the left corner line F and the right corner line G at the back can be used as auxiliary lines for designing a net base (a cap base) of the wig, which is convenient for designers to find out angles of dividing lines at the back of the net cap. The method for positioning hairline contours with different head circumference sizes according to the present application enables the wig designers to grasp the correct positions of the hairline and the divisions of the human head more simply and quickly, thereby improving the wig production efficiency. The head model with the hairline contour made by using the method fills the gap in wig design teaching model.

### Second Embodiment

The method for positioning hairline contours with different head circumference sizes is provided in the first embodiment, and a head model is provided in this embodiment based on the method for positioning hairline contour according to the first embodiment. A hairline contour is drawn on the head model, and the hairline contour can be drawn by using the method for positioning hairline contours with different head circumference sizes according to the first embodiment.

Referring to FIG. 6 and FIG. 7, the hairline contour on the head model is divided into a top horseshoe region, a posterior brain region, a left brain region and a right brain region. The top horseshoe region is surrounded by the skull top U-shaped line at the skull top of the head model; the posterior brain region is surrounded by the left corner line, the right corner line, the skull top U-shaped line and the skull base line, the left brain region is surrounded by the left corner line, the skull top U-shaped line and a left part of the hairline contour, and the right brain region is surrounded by the right corner line, the skull top U-shaped line and a right part of the hairline contour.

The trichion and the golden section point are indicated on the centerline of the skull of the head model provided in this embodiment. The centerline of the skull and the skull top U-shaped line intersect at two intersection, one of the intersections is the trichion, and another of the intersections is the golden section point. The golden section point is a point at which the surface of the skull intersects with a bisector of an included angle, formed by a horizontal straight line passing through a highest point on the skull top and a vertical straight line passing through the highest point on the back surface of the head.

The head model according to the embodiment may be a head model with any size, and the hairline contour drawn on the head model is calculated adaptively based on the different sizes of the head model, which has a high matching degree with the real human head.

### Third Embodiment

The method for positioning hairline contours with different head circumference sizes is provided in the first embodiment, and the head model is provided in the second embodiment based on the method for positioning hairline contour according to the first embodiment, a hairline contour is drawn on the head model according to the second embodiment, and the hairline contour may be drawn by using the method for positioning hairline contours with different head circumference sizes according to the first embodiment.

A wig is provided in this embodiment based on the method for positioning hairline contours with different head circumference sizes according to the first embodiment and the head model according to the second embodiment.

At present, there are just some props used to show hairstyles in the market. However, a cap base (or a net base) needs to be designed in the wig patterning design, and the design of the cap base needs the correct hairline contour line, hair dividing lines and the model head with a standard size to assist in pattern making. However, modeling tools used to assist in making the cap base in the conventional technology cannot meet the requirements of design of the cap base. Therefore, the wig made in the conventional technology always does not fit with real people, and the effect is not satisfactory.

In order to solve the problems existing in the conventional technology, the method for positioning hairline contours with different head circumference sizes is provided according to the present application, which can be used to determine hairline contours with different head circumference sizes, to obtain a head model which can be used for the design of the cap base, thereby making a wig with high matching degree with real people.

The wig according to this embodiment includes a net base. A contour of the net base is adapted to the hairline contour of a human head; and the contour of the net base is drawn by using the method for positioning hairline contours with different head circumference sizes according to the first embodiment. Certainly, in the actual production process, the hairline contour can be drawn on the human head model according to target requirements, and the hairline contour is positioned and drawn by using the method for positioning hairline contours with different head circumference sizes according to the present application. While the hairline contour is drawn on the human head model, the accurate division of the head of the head model is realized. Reference is made to the second embodiment for the division, which is not repeated here. After the hairline contour is drawn on the human head model and the division is realized, the wig can be customized by using the head model, and the net base of the wig can be adaptively made based on the hairline contour of the head model.

Therefore, the head model according to the present application is provided with the hairline contour (which is adapted to the size of the human head) and the dividing lines, and the marking of the points in the divisions of the human head arranged on the head model can well provide corresponding problem-solving solutions for wig designers and hairdressing teaching.

In summary, the method for positioning hairline contours with different head circumference sizes according to the present application can be used to determine and calculate the positioning of points and the division of the contour lines on the hairline contours of the human heads with different head circumference sizes. A head model on which the hairline and the division of the human head can be marked is provided for wig design, wig shaping, and hairdressing teaching. In wig production, the hairline contours with different head circumferences sizes can be determined by using the method for positioning hairline contours with different head circumference sizes, and the auxiliary lines for the design of the net base of the wig can be obtained, which is convenient for designers to find out angles of dividing lines at the back of the net cap, and make a wig that is more suitable for the human head. With the method for positioning hairline contours with different head circumference sizes according to the present application, a theoretical basis is provided for a method for drawing the hairline contours under different head circumference sizes, which facilitates the relevant operators to deepen their perception of hairline contours, thereby improving a matching degree of technology applied in the practical operation process.

Technical features in the foregoing embodiments may be combined arbitrarily (as long as the combination of these technical features is not contradictory). For conciseness of description, not all possible combinations of the technical features in the foregoing embodiments are described. These embodiments that are not described should be considered within the scope of this specification.

The present application has been described in detail through general description and specific embodiments, It should be understood that some conventional adjustments or further innovations may be made to these specific embodiments based on the technical concept of the present application. However, the technical solutions obtained based on the conventional adjustments or further innovations without departing from the technical concept of the present application still fall within the scope of protection of the claims of the present application.

1. A method for positioning hairline contours with different head circumference sizes, comprising the following steps:
S1: determining a trichion, wherein the trichion is located at a center of a top of a forehead;
S2: determining a center point of a head, wherein the center point of the head is located on a surface of a skull top and is a center point of a total head length, and the total head length is a connecting line between a highest point on a forehead surface and a highest point on a back surface of the head;
S3: determining a skull top U-shaped line based on the trichion and the center point of the head;
S4: determining frontal horn points based on the skull top U-shaped line and temporal bone lines of the head;
S5: determining front side points;
S6: determining sidebums points;
S7: determining ear points;
S8: determining neck side points;
S9: determining a skull base line; and
S10: connecting, based on a trend of facial muscles, the trichion, the frontal horn points, the front side points, the sidebums points, the ear points, the neck side points and the skull base line in a smooth transition manner in a listed sequence, to obtain a hairline contour.

2. The method according to claim 1, wherein a vertical distance from the trichion in step S1 to the skull top is equal to a difference between a total head height and a face length, the total head height is a vertical distance from the skull top to a mandible bottom, and the face length is a vertical distance from the mandible bottom to the trichion; wherein
in step S3, the determining a skull top U-shaped line comprises the following steps:
S31: determining a centerline of a skull, wherein the centerline of the skull passes through the trichion and the center point of the total head length in a listed sequence, and the centerline of the skull divides the skull into a left half and a right half;
S32: rotating the centerline of the skull by 45 degrees to a left side and a right side to obtain a left auxiliary line and a right auxiliary line, wherein a rotation center is the center point of the head; rotating the centerline of the skull by 90 degrees to obtain a head width auxiliary line perpendicular to the centerline of the skull, wherein the rotation center is the center point of the head, and the head width auxiliary line divides the skull into a front half and a rear half; and
S33: determining, on a surface of the skull, positioning points located at the centerline of the skull, the left auxiliary line, the right auxiliary line and the head width auxiliary line based on the vertical distance from the trichion to the skull top, wherein a vertical height from each of the positioning points to the skull top is the same as the vertical height from the trichion to the skull top; and connecting the positioning points sequentially to obtain the skull top U-shaped line;
wherein the centerline of the skull and the skull top U-shaped line intersect at two intersections, one of the intersections is the trichion, another of the intersections is a golden section point, wherein the golden section point is a point at which the surface of the skull intersects with a bisector of an included angle, formed by a horizontal straight line passing through a highest point on the skull top and a vertical straight line passing through the highest point on the back surface of the head.

3. The method according to claim 2, wherein the determining frontal horn points based on the skull top U-shaped line and temporal bone lines of the head in step S4 comprises:
each of a left side and a right side of the forehead of a face is provided with a frontal horn point, and the two frontal horn points are intersections between the temporal bone lines on two sides and the skull top U-shaped line, respectively;
the two frontal horn points are referred to as a left frontal horn point and a right frontal horn point, wherein the left frontal horn point is an intersection between the left auxiliary line and a portion, close to the forehead, of the skull top U-shaped line; and the right frontal horn point is an intersection between the right auxiliary line and the portion, close to the forehead, of the skull top U-shaped line.

4. The method according to claim 2, wherein the determining front side points in step S5 comprises:
each of a left side and a right side of a face is provided with a front side point, wherein the front side points are located on two sides of the forehead and located at intersections between temporal bone lines and a skull line, respectively;
the front side points comprise a first front side point and a second front side point;
the first front side point is located above the second front side point, and the first front side point is closer to the forehead surface than the second front side point;
the first front side point is an intersection between the left auxiliary line and a left temporal bone line, or, the first front side point is an intersection between the right auxiliary line and a right temporal bone line;
a connecting line between the first front side point and the second front side point on a same side is parallel to a straight line at an angle of 45 degrees obliquely downward from an upper edge of an orbit, and intersects with an extended straight line of a brow bone; and
the second front side point is an intersection between the straight line at the angle of 45 degrees obliquely downward from the upper edge of the orbit and the extended straight line of the brow bone.

5. The method according to claim 4, wherein the determining sidebums points in step S6 comprises:
each of the left side and the right side of the face is provided with a sidebums point, wherein each of the sidebums points is an intersection between an end of a facial zygomatic bone and an auricular bone;
the front side points, the sidebums points and the ear points are connected to form a sidebums hairline contour, wherein the sidebums hairline contour comprises a first-section sidebums hairline contour and a second-section sidebums hairline contour;
the first-section sidebums hairline contour is formed by the second front side point intersecting vertically downward with a side zygomatic bone;
the second-section sidebums hairline contour is formed by extending each of the ear points obliquely downward along a corresponding ear to intersect with the end of the side zygomatic bone, and the first-section sidebums hairline contour and the second-section sidebums hairline contour intersect at the sidebums point.

6. The method according to claim 2, wherein the determining ear points in step S7 comprises:
ears are formed on a left side and a right side of the skull, and the ear points are located above the ears; wherein each of the ear points is an intersection between the head width auxiliary line and a skull line above a corresponding ear, and a connecting line between the ear point and the sidebums point follows a trend of the skull line.

7. The method according to claim 2, wherein the determining neck side points in step S8 comprises:
the neck side points are located at a back of the head and opposite to a face, a left side and a right side of the back of the head are symmetrically provided with the neck side points, which are referred to as a left neck side point and a right neck side point;
the left neck side point is an intersection between a line, which extends downward along the surface of the skull from a starting point, and an extension line of a connecting line between a nasal floor and an ear floor on the surface of the skull, wherein the starting point is an intersection between an end, close to the back of the head, of the right auxiliary line and the skull top U-shaped line;
the right neck side point is an intersection between a line, which extends downward along the surface of the skull from a starting point, and an extension line of a connecting line between the nasal floor and an ear floor on the surface of the skull, wherein the starting point is an intersection between an end, close to the back of the head, of the left auxiliary line and the skull top U-shaped line;
wherein the line that extends downward along the surface of the skull from the starting point, which is the intersection between the end, close to the back of the head, of the right auxiliary line and the skull top U-shaped line, is referred to as a left corner line, and the line that extends downward along the surface of the skull from the starting point, which is the intersection between the end, close to the back of the head, of the left auxiliary line and the skull top U-shaped line, is referred to as a right corner line;
a connecting line between the ear point and the left neck side point or a connecting line between the ear point and the right neck side point is referred to as an auricular line, and the auricular line is a curve that extends and transits forward along the skull line at a back of the ear.

8. The method according to claim 7, wherein the determining a skull base line in step S9 comprises:
the skull base line is located at the back of the head and below the left neck side point and the right neck side point, wherein the skull base line is an extension line of a connecting line between two ends of corners of a mouth along the surface of the skull, the skull base line forms a dividing line between the head and a neck, the left neck side point and the right neck side point each is connected with the skull base line through a transition line, and the transition lines are smooth curves.

9. A head model, wherein a hairline contour is drawn on the head model, and the hairline contour is drawn by using the method for positioning hairline contours with different head circumference sizes according to claim 7;
the hairline contour on the head model is divided into a top horseshoe region, a posterior brain region, a left brain region and a right brain region; wherein
the top horseshoe region is surrounded by the skull top U-shaped line at the skull top of the head model;
the posterior brain region is surrounded by the left corner line, the right corner line, the skull top U-shaped line and the skull base line;
the left brain region is surrounded by the left corner line, the skull top U-shaped line and a left part of the hairline contour;
the right brain region is surrounded by the right corner line, the skull top U-shaped line and a right part of the hairline contour; and
the trichion and the golden section point are indicated on the centerline of the skull of the head model.

10. A wig, comprising a net base, wherein a contour of the net base is adapted to a hairline contour of a human head; and the contour of the net base is drawn by using the method for positioning hairline contours with different head circumference sizes according to claim 7.
